(19) United States
(12) Patent Application Publication
(10) Pub. No.: US 2020/0026671 A1
(43) Pub. Date: Jan. 23, 2020

(54) CIRCUITRY SYSTEM AND METHOD FOR PROCESSING INTERRUPT PRIORITY

(71) Applicant: REALTEK SEMICONDUCTOR CORP., Hsinchu City (TW)

(72) Inventors: XIAO-XING FEI, SUZHOU (CN); SHAN-JIAN FEI, SUZHOU (CN)

(21) Appl. No.: 16/515,689

(22) Filed: Jul. 18, 2019

(30) Foreign Application Priority Data
Jul. 20, 2018 (CN) 201810802685.X

(51) Int. Cl. G06F 13/26; G06F 9/48

(52) U.S. Cl. CPC G06F 13/26; G06F 2213/2412; G06F 9/4818

(57) ABSTRACT

The disclosure is related to a circuitry system and a method for processing interrupt priority. The circuitry system is such as a system-on-chip that operates the method. The high-priority interrupt is configured to be always on and prohibited from accessing a critical section. When a high-priority interrupt occurs as a processor of the system is in operation, the processor sets a low-priority interrupt to access the critical section where the high-priority interrupt accessed previously. When the low-priority interrupt is terminated, the processor determines whether or not to wake up the unfinished task that is previously set for the high-priority interrupt. The processor continues processing the task since the task has not been finished. The circuity system can therefore retain the characteristics of all disabled interrupts and also maintain an instantaneity for the important tasks of the system.

### CROSS-REFERENCE TO RELATED PATENT APPLICATION

This application claims the benefit of priority to China Patent Application No. 201810802685.X, filed on Jul. 20, 2018 in People's Republic of China. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The disclosure is generally related to a method and a system for processing interrupts, and more particularly to a system-on-chip with an interrupt priority mechanism that is characterized in always enabling specified high-priority interrupts in a process for maintaining features of a disabled interrupt, and the method thereof for processing interrupt priority.

### BACKGROUND OF THE DISCLOSURE

A System on Chip (SoC) is an integrated circuit that integrates various systems with multiple functions. SoC is widely used by IC designers. In the SoC, multiple subsystems or their inside systems are configured to be communicated with each other via a bus.

The subsystems of SoC share the common data. The traditional subsystems utilize an interrupt mechanism to perform the inside communications in order to control data accessing. The interrupts are controlled by an interrupt controller in a central processing unit (CPU) of the system. The interrupt controller communicates with the various subsystems and the CPU. Once one of the subsystems launches an interrupt, the CPU of SoC acknowledges the interrupt from the interrupt controller.

When the system is in operation, the subsystem generates an interrupt signal for notifying the CPU. The interrupt controller of the CPU receives the interrupt signal and then determines which subsystem triggers the interrupt. In the meantime, an interrupt service routine (ISR) is initiated to process this interrupt for allowing the subsystem to use the data without interference.

FIG. 1 shows a circuit block diagram of a conventional SoC.

The SoC inside an electronic system includes a CPU 110 with an interrupt controller 115 that is used to manage the interrupt signals. Inside the SoC, the resources to be shared such as a memory 111 and a sensor 112 exchange messages via a bus 10. The SoC exemplarily includes several subsystems 101 to 105. Every subsystem may have its own subsystem. The subsystems 101 to 105 can be implemented by the functional modules of the SoC. The subsystem generates an interrupt signal if it demands the common resources. The interrupt controller 115 receives the interrupt signal from the subsystem and sends it to other subsystems.

In most of the processes for processing instant message, a disabled interrupt approach is generally a solution to embody a critical section. When a program performed by a processor is to process a code of the critical section thereon, the simplest approach to prevent another instruction accessing the critical section by disabling interrupt on entry into the critical section.

However, the approach greatly affects instantaneity of the system since the disabled interrupt may also disable the high-priority interrupt when disabling the low-priority interrupt.

### SUMMARY OF THE DISCLOSURE

In response to the above-referenced technical inadequacies, the present disclosure provides a circuitry system and a method for processing interrupt priority.

The present disclosure is related to a circuitry system for processing interrupt priority and a method thereof. The circuitry system is such as a System-On-Chip (SoC). One of the objectives of the invention is to use the characteristics of interrupt priority of the SoC to keep the high-priority interrupt always on. In the approach of the invention, a processing function of the high-priority interrupt prohibits a processor from accessing a critical section, and a processing function of the low-priority interrupt is allowed to access the critical section. The approach not only continues to use the conventional disabled interrupt to embody the critical section, but also maintains instantaneity of the system.

According to one of the embodiments, the circuitry system operates the method for processing the interrupt priority, and the circuitry system can be applied to a real-time operating system. When a processor of the circuitry system performs a task, the processor receives a high-priority interrupt that is originally for accessing the critical section. However, through a flag state or a bit state, a low-priority interrupt is set for accessing and processing the data of critical section where the high-priority interrupt previously applied for accessing since the high-priority interrupt is configured to prohibit the processor from accessing the critical section. Next, when returning the low-priority interrupt, the processor determines whether or not to wake up the unfinished task previously set for the high-priority interrupt. If the unfinished task exists, the processor continues to process the unfinished task under the high-priority interrupt.

It should be noted that, in one aspect, the unfinished task means a common work performed by the processor originally without initiating any interrupt, or the task performed by the processor can also be the task under the low-priority interrupt.

According to one embodiment of the circuitry system, the circuitry system is a System-On-Chip. The circuitry system includes a processor and one or more subsystems. The processor performs the method for processing interrupt priority that can be operated in a real-time operating system. When the processor is in operation, a low-priority interrupt is set for accessing a critical section where the high-priority interrupt is configured to access if a high-priority interrupt occurs. After that, the processor goes on initiating a task for processing the unfinished task previously set for the high-priority interrupt.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 shows a schematic circuit block diagram of a conventional SoC;

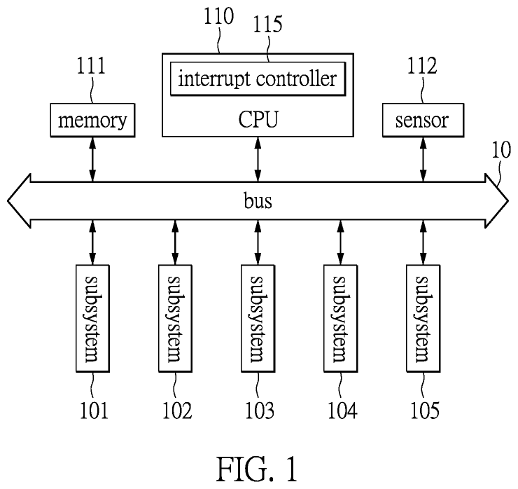

FIG. 2 shows a flow chart describing a method for processing interrupt priority in one embodiment of the disclosure;

FIG. 3 shows another flow chart describing a process for processing interrupt priority for a high-priority interrupt occurs when processing an ordinary task according to one embodiment of the disclosure;

FIG. 4 shows a flow chart describing a process for processing interrupt priority for a high-priority interrupt occurs when the SoC is processing the low-priority interrupt according to one further embodiment of the disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

The disclosure is related to a method for processing interrupt priority and a circuitry system. One of the objectives of the method is to utilize characteristics of interrupt priority applied to a SoC (System-On-Chip) that uses a disabled interrupt to implement a critical section, which on the other hand makes a high-priority interrupt applied to a CPU always on. For example, the tasks such as the computer procedure relating to security, emergency treatment or important threads, performed by the CPU under the high-priority interrupt may not be affected by another interrupt. Therefore, the high-priority interrupt will be set always-on in this aspect for keeping the system's instantaneity for the important tasks.

The interrupt priority denotes an interrupt state that is a high-priority interrupt or a low-priority interrupt. The interrupt state is written to a register of an interrupt controller, or managed by a software program.

However, it is necessary for the central processing unit (CPU) of the system to set the high-priority interrupt as an always-on state in the computer procedure even if the interrupt still administrates how the subsystem uses the system resources. For example, to maintain the instantaneity of the system's process, the high-priority interrupt for the system may be necessary to be always-on for processing the procedure concerning security or the procedure requiring instant response when the SoC is applied to a Real-Time Operating System (RTOS).

Most RTOSs use disabled interrupt to embody the critical section. The critical section refers to a code segment that can be accessed by interrupts and the kernel, e.g. the inner threads, at the same time, for example when a user accesses data in the critical section via a SoC so as to form a thread in the CPU for executing a code of the critical section. The data received by the threads may be inconsistent or erroneous due to the data in the critical section not being able to be accessed by threads of the subsystems at the same time. Therefore, the disabled interrupt approach is generally used to prohibit other threads from accessing the critical section. The only drawback of the approach is that the disabled interrupt turns off the low-priority interrupt and also makes the high-priority interrupt to be masked. Thus, the high-priority interrupt may fail to get the instant processing and so there will be some loss in instantaneity.

According to one embodiment of the circuitry system for processing the interrupt priority of the disclosure, the disabled interrupt approach that masks the low-priority interrupt is used to implement the critical section. The critical section allows the real-time operating system not to affect the original process and effectively enhance the instantaneity of the real-time operating system.

The abovementioned SoC includes a processor and one or more subsystems. The processor performs the method for processing interrupt priority. An internal interrupt controller of the processor or an external interrupt controller outside the system is responsible for processing the interrupt signals triggered by each of the subsystems. It should be noted that the subsystem is such as a module of the SoC. Each of the subsystems launches a request and sends it to the processor by the interrupt controller. The processor can orderly arrange the interrupt services according to a priority order. When one of the subsystems triggers an interrupt, the interrupt controller is in charge of communicating with other subsystems. A corresponding interrupt signal and an interrupt request are transmitted to the processor in the meantime. The interrupt controller forwards the interrupt request to the processor when receiving the interrupt signal. The interrupt controller accordingly performs a handling program.

In an exemplary example, the processor of SoC supports 16 interrupts, in which number 0 to 7 of the interrupts are classified into low-priority interrupts with the same priority order, and can only be interrupted by the high-priority interrupt; number 8 to 15 of the interrupts are the high-priority interrupts that have the same interrupt.

In the present embodiment, a rule for processing the interrupt service routine is provided. In the rule, the conventional disabled interrupt approach is modified as masking the low-priority interrupt, and the enabled interrupt approach is replaced by the approach for unmasking the low-priority interrupt. Further, the high-priority interrupt is set as always on according to the rule. A processing function of the low-priority interrupt is allowed to access the critical section. The high-priority interrupt can be applied to handle any instant task when it is set as always on. However, the processing function of the high-priority interrupt is prohibited to access the critical section. The high-priority interrupt accomplishes message delivery by communicating with the low-priority interrupt. For example, an interrupt flag is incorporated for the communication so as to wake up the task when returning the low-priority interrupt and continue processing the unfinished task previously set for the high-priority interrupt.

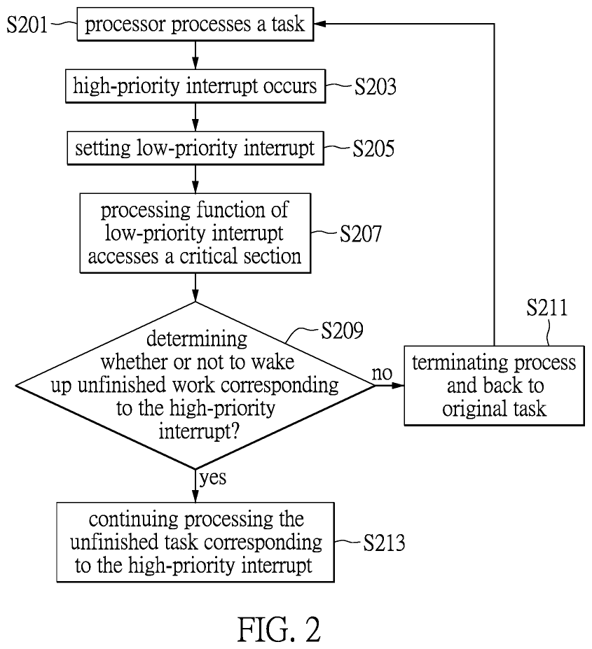

FIG. 2 shows a flow chart describing the method for processing interrupt priority based on the abovementioned rule in one embodiment of the disclosure. Before the steps of the method, the system performs a preceding procedure that sets the high-priority interrupt to be an always-on interrupt for processing the instant task. A processing function of the priority interrupt is prohibited to access the critical section. A processing function of the low-priority interrupt is set to allow accessing the critical section.

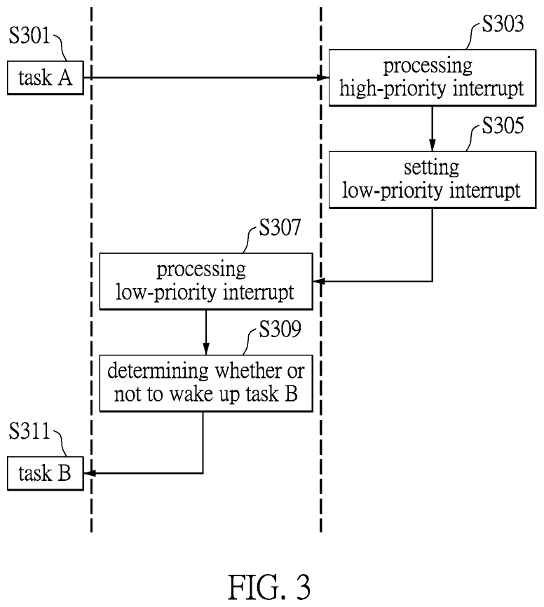

In the beginning, such as in step S201, a CPU of SoC processes a work that is a regular task without interrupt process. The task can be a task A (referring to FIG. 3) that is performed by a thread of the CPU. The task can also be a regular task for processing the low-priority interrupt. In the meantime, such as in step S203, a high-priority interrupt occurs. The CPU of SoC or an internal interrupt controller of SoC receives a request for this high-priority interrupt. The task of the high-priority interrupt is to access a critical section that generally means a more emergent event. However, the high-priority interrupt is configured to be prohibited to access the critical section according to the embodiment of the disclosure. Therefore, the CPU delivers a signal to the low-priority interrupt by setting a flag or a bit state (0/1) when the CPU receives an interrupt request, such as in step S205. The flag or the bit state is to unmask the low-priority interrupt for accessing the critical section where the high-priority interrupt accessed previously.

Since the low-priority interrupt is configured to allow accessing the critical section, the data in the critical section can also be accessed by a regular task. When the processor of the SoC is notified through an interrupt flag, a thread of the SoC unmasks the low-priority interrupt. In step S207, a processing function of the low-priority interrupt is allowed to access the critical section.

Next, when returning the low-priority interrupt, the low-priority interrupt is masked. In step S209, the processor determines whether or not to wake up the unfinished task previously set for the high-priority interrupt. If it is determined that the unfinished task may not be continued, in step S211, the process is terminated and the system goes back to the original task, e.g. task A of FIG. 3. Otherwise, if there is still an unfinished task previously set for the high-priority interrupt, in step S213, the unfinished task, e.g. task B of FIG. 3, is woken up and the processor continues to process the unfinished task.

The embodiments and figures described below are used to depict the process for processing interrupt priority of the disclosure.

### Embodiment 1

FIG. 3 shows a flow chart describing a process for processing interrupt priority as a high-priority interrupt occurs when the system processes a regular task.

When the system performs a regular task (task A) (step S301), a high-priority interrupt which generally relates to an instant or emergent task occurs, the system instantly processes the high-priority interrupt (step S303).

For example, the original task of high-priority interrupt is to access a critical section but the system sets the high-priority interrupt to be always on and prohibits the processing function of the high-priority interrupt from accessing the critical section. Accordingly, the processor uses the flag to set the low-priority interrupt (step S305), and causes the system to be able to handle the low-priority interrupt. In an exemplary example, the processor causes the low-priority interrupt to access and process data in the critical section where the high-priority interrupt was designed to access previously (step S307). After the low-priority interrupt has accessed the data in the critical section, it is determined whether or not to wake up the previous unfinished task, e.g. task B, set for the high-priority interrupt (step S309). If there is still an unfinished task, the system assigns the task B to be the task while returning the low-priority interrupt to wake the task B (step S311).

### Embodiment 2

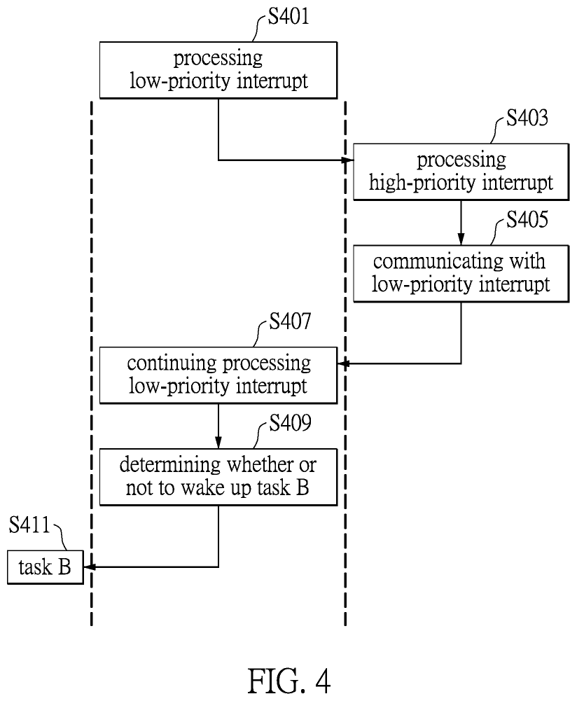

Reference is made to FIG. 4 exemplarily showing a flow chart describing the process as the high-priority interrupt occurs when the processor of SoC processes the low-priority interrupt.

When the processor processes the task set for the low-priority interrupt (step S401), the processor may then take over the high-priority interrupt when receiving a signal of the high-priority interrupt (step S403). After that, when the high-priority interrupt is in process, the high-priority interrupt still communicates with the low-priority interrupt for delivering the message (step S405) for processing the next task set for the low-priority interrupt (step S407). Next, the system determines whether or not to wake up the task B by checking if the previous task set for the high-priority interrupt has been finished (step S409). If the task B set for the high-priority interrupt is not finished, the system assigns the task B to the high-priority interrupt (step S411). The task B is assigned for going on to the unfinished task under the high-priority interrupt.

According to the above embodiments of the disclosure, in the method for processing the interrupt priority, the system provides a mechanism that re-sets the disabled interrupt and makes the high-priority interrupt to be always on for instantaneously processing the instant task. The low-priority interrupt is masked for processing the regular task for maintaining the characteristics of a disabled interrupt. It should be noted that the instantaneity of the system can be enhanced as well as the disabled interrupt approach satisfying the processing requirement of a critical section.

In summation, the method for processing interrupt priority and the circuitry system are adapted to the SoC adopting the mechanism of interrupt priority. The method can be used to improve the interrupt service routine of an operating system. The high-performance interrupt processing process allows the high-priority interrupt to respond to any instant circumstance, and the task previously set for the high-priority interrupt can always be prioritized. Therefore, the emergent or the most important task can be processed instantaneously.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A circuitry system, comprising:
a processor and one or more subsystems, wherein the processor is used to perform a method for processing interrupt priority, in which a high-priority interrupt applied to the processor is set as an always-on interrupt for processing any instant task.

2. The system as recited in claim 1, wherein the method for processing interrupt priority performed by the processor of the circuitry system further comprises:
receiving a high-priority interrupt by the processor for accessing a critical section when the processor performs a task;
setting a low-priority interrupt for the processor to access and process data in the critical section where the high-priority interrupt is applied for the processor to access;
the processor determining whether or not to wake up the task which is not finished under the high-priority interrupt when returning the low-priority interrupt; and
the processor continuing processing the unfinished task under the high-priority interrupt.

3. The system as recited in claim 2, wherein the circuitry system is a System-On-Chip.

4. The system as recited in claim 2, wherein the one or more subsystems issues the high-priority interrupt or the low-priority interrupt to the processor.

5. The system as recited in claim 2, wherein the circuitry system is operated in a computer system, and the method for processing interrupt priority is operated to a real-time operating system.

6. The system as recited in claim 2, wherein the original task performed by the processor is a task without an interrupt.

7. The system as recited in claim 2, wherein the original task performed by the processor is a task with the low-priority interrupt.

8. The system as recited in claim 2, further comprising a preceding procedure that sets the high-priority interrupt to be the always-on interrupt, and a processing function of the priority interrupt is prohibited to access the critical section.

9. The system as recited in claim 8, wherein a processing function of the low-priority interrupt is configured to allow accessing the critical section.

10. The system as recited in claim 9, wherein the step for setting the low-priority interrupt is to set a flag state or a bit state for notifying the low-priority interrupt.

11. A method for processing interrupt priority, comprising:
receiving a high-priority interrupt by a processor for accessing a critical section when the processor performs a task, wherein the processor sets the high-priority interrupt as an always-on interrupt for processing any instant task;
setting a low-priority interrupt for the processor to access and process data in the critical section where the high-priority interrupt is applied for the processor to access;
the processor determining whether or not to wake up the task which is not finished under the high-priority interrupt when returning the low-priority interrupt; and
the processor continuing processing the unfinished task previously set for the high-priority interrupt if the task is woken up.

12. The method as recited in claim 11, wherein the method is applied to a circuitry system that includes the processor and one or more subsystems.

13. The method as recited in claim 12, wherein the one or more subsystems issues the high-priority interrupt or the low-priority interrupt to the processor.

14. The method as recited in claim 11, wherein the circuitry system is operated in a computer system, and the method for processing interrupt priority is operated to a real-time operating system.

15. The method as recited in claim 14, wherein the original task performed by the processor is a task without an interrupt.

16. The method as recited in claim 14, wherein the original task performed by the processor is a task with the low-priority interrupt.

17. The method as recited in claim 16, wherein the step for setting the low-priority interrupt is to set a flag state or a bit state for notifying the low-priority interrupt.

18. The method as recited in claim 11, further comprising a preceding procedure that sets the high-priority interrupt to be the always-on interrupt, and a processing function of the priority interrupt is prohibited to access the critical section.

19. The method as recited in claim 18, wherein a processing function of the low-priority interrupt is configured to allow accessing the critical section.

20. The method as recited in claim 19, wherein the step for setting the low-priority interrupt is to set a flag state or a bit state for notifying the low-priority interrupt.
